(19) United States
(12) Patent Application Publication
(10) Pub. No.: US 2011/0275385 A1
(43) Pub. Date: Nov. 10, 2011

(54) System and Methods for Observed Time Difference of Arrival Measurements for Location Services in Cellular Devices

(75) Inventors: Alberto Escolar-Piedras, Valby (DK); Mika Ventola, Oulu (FI); Gilles Charbit, Farnborough (GB)

(73) Assignee: Nokia Corporation, Espoo (FI)

(21) Appl. No.: 13/103,764

(22) Filed: May 9, 2011

Related U.S. Application Data
(60) Provisional application No. 61/333,149, filed on May 10, 2010.

(51) Int. Cl. H04W 4/00; H04W 24/00

(52) U.S. Cl. 455/456.1

(57) ABSTRACT

Systems and methods for providing improved location such as emergency services location of mobile devices in an over the air communications system are disclosed. On receiving a request, a user equipment (UE) mobile device makes observed time difference of arrival (OTDOA) measurements on signals received from certain cell communication elements. The UE selects or prioritizes the cells based on one of several schemes, including comparing internally stored cell ID information to cell ID information provided by the network, and using lists of cells that are recently used, recently received, previously used, or on a closed subscriber group (CSG) list are alternative embodiments. The UE may prioritize home eNB cells that it is a member of for the measurements. By prioritizing the cells used for the measurements, the OTDOA measurements may be limited to a few cells and the time needed to make the measurements may be reduced.

This application claims the benefit of U.S. Provisional Application No. 61/333,149, entitled “System and Methods for Observed Time Difference of Arrival Measurements for Location Services in Cellular Devices,” filed on May 10, 2010 which is incorporated herein by reference.

### TECHNICAL FIELD

The present invention relates to a system and methods for providing an improved user equipment or mobile device location method for locating portable cellular user equipment. More particularly, the present invention relates to a system and methods for providing the observed time difference of arrival measurements used in determining receiver location, for example in an emergency situation, using time and cost efficient implementations, while providing conservation of device and system resources.

### BACKGROUND

As wireless communication systems such as cellular telephone, satellite, and microwave communication systems become more widely deployed and continue to attract a growing number of users, there is a pressing need to accommodate a large and variable number of communication subsystems transmitting a growing volume of data with a fixed resource such as a fixed channel bandwidth accommodating a fixed data packet size. Traditional communication system designs employing a fixed resource (e.g., a fixed data rate for each user) have become challenged to provide high, but flexible, data transmission rates in view of the rapidly growing customer base.

Current systems implement wireless communications using standard protocols including Universal Mobile Telecommunications System (“UMTS”), UMTS Terrestrial Radio Access Network (“UTRAN”), and third generation wireless (“3G”), Wideband Code Division Multiple Access (“WCDMA”), for examples, which support HDSPA communications between mobile equipment. The mobile equipment includes user equipment (“UE”) such as cell phones, and fixed transceivers that support mobile telephone cells, such as base stations, referred to as “Node B” (or “NB”) and when enhanced, or evolved to a new standard protocol, referred to as “e-Node B”(or “eNB”).

The Third Generation Partnership Project Long Term Evolution (“3GPP LTE”) is the name generally used to describe an ongoing effort across the industry to improve UMTS. The improvements are being made to cope with continuing new requirements and the growing base of users. Goals of this broadly based project include improving communication efficiency, lowering costs, improving services, making use of new spectrum opportunities, and achieving better integration with other open standards and backwards compatibility with some existing infrastructure that is compliant with earlier standards.

UTRAN includes multiple Radio Network Subsystems (“RNS”), each of which contains at least one Radio Network Controller (“RNC”). However, it should be noted that the RNC may not be present in the actual future implemented systems incorporating Long Term Evolution (“LTE”) of UTRAN, evolved UTRAN (“E-UTRAN”). LTE may include a centralized or decentralized entity for control information. In UTRAN operation, each RNC may be connected to multiple Node Bs which are the UMTS counterparts to Global System for Mobile Communications (“GSM”) base stations. In E-UTRAN systems, the e-Node B may be, or is, connected directly to the access gateway (“aGW,” sometimes referred to as the services gateway “sGW”). Each Node B may be in radio contact with multiple UE devices (generally, user equipment including mobile transceivers or cellular phones, although other devices such as fixed cellular phones, mobile web browsers, laptops, PDAs, MP3 players, and gaming devices with transceivers may also be UE) via the radio air interface.

The wireless communication systems as described herein are applicable to, for instance, 3G, and UTRAN systems. In the future, 3GPP LTE compatible wireless communication systems will be implemented. In general, E-UTRAN resources are assigned by the network to one or more UE devices by use of various resource allocation means, or more generally by use of a downlink resource assignment channel or physical downlink control channel (“PDCCH”). LTE is a packet-based system and, therefore, there may not be a dedicated connection reserved for communication between a UE and the network. Users are generally scheduled on a shared channel every transmission time interval (“TTI”) by a Node B or an e-Node B. A Node B or an e-Node B controls the communications between user equipment terminals in a cell served by the Node B or e-Node B. In general, one Node B or e-Node B serves each cell. Resources needed for data transfer are assigned either as one time assignments or in a persistent/semi-static way. The LTE, also referred to as 3.9G, generally supports a large number of users per cell with quasi-instantaneous access to radio resources in the active state.

There are many types of UEs and services the UTRAN and E-UTRAN environment can accommodate. Recently, requirements for wireless systems to provide certain emergency services have emerged, including requirements for emergency 911 (“e911”) services. To provide emergency service support, the system must be able to perform location of a caller using mobile telephone equipment, that is the system and equipment must provide an accurate physical location of the device. This procedure is to be done in response to a system request and standards requirements are being developed that require certain positional accuracy and a final response within a certain amount of time. This is needed in order to enable emergency services providers to rapidly locate and respond to a caller using a mobile device during an emergency.

To support rapid location of a mobile device, in the present systems and known approaches, the UEs maybe required to make signal observations from many possible eNBs and to determine the observed time difference in arriving signals from all of them. Then these measurements are reported to the network where computations are performed to determine the location of the UE. Using the physical known locations of the cell eNBs, the possible locations of the user equipment may be refined to a single physical location, or a small area. Multilateration may be used and an area identified where multiple possible device location solutions or curves intersect. In this manner a definite physical location for a receiver, with substantial accuracy, may be determined. However the known approaches proposed thus far require many network and user equipment resources, consume substantial power in the user equipment, and may take a longer time to converge to a positional solution than required, so that in some instances the system may not meet the requirements using the approaches of the prior art.

A continuing need thus exists for systems and methods to efficiently perform the mobile and network operations used in UE location services, and especially location services performed in support of emergency services such as e911. Circuitry and methods to implement these functions with efficient use of hardware, having time efficiency, and conservation of power resources are also needed.

### SUMMARY OF THE INVENTION

These and other problems are generally solved or circumvented, and technical advantages are generally achieved, by advantageous embodiments of the present invention which include an apparatus and methods for providing the UE observed time difference measurements needed for location services.

According to an illustrative embodiment, an exemplary communication terminal such as a UE (typically a mobile phone or cell phone) is provided that may implement, in response to a message, making observed time difference of arrival (OTDOA) measurements from certain communication elements. The UE will make measurements for the communication elements it can reliably detect, that is, the communication elements for which the received signal has sufficient signal to noise ratio (SNR) and the data received can be retrieved (acceptable signal quality) reliably. A communication element such as an eNB that sends signals that can be reliably detected by the UE can be “heard” by the UE, or is one the UE can “hear”, these terms are used in this manner in the discussion that follows. In addition to the network provided information on communication elements that the UE may use to determine which reference signals to listen for, the UE may prioritize the selection of the communication elements to be listened to based on a variety of parameters. These parameters include prioritizing the selection based on a neighbors list maintained by the UE for use in mobility support, using a closed subscriber group (CSG) list of eNBs, assigning higher priority to eNBs for smaller range cells such as home eNB, femtocells, and pico-eNB cells, comparing the UE stored lists to the list provided by the network and prioritizing the eNB cells that appear on both lists, and any combination of the above. The UE may store received signal time difference measurements (“RSTD”) for return to the network. Using these measured time differences and the known locations of the eNBs; the network may perform a computation and determine a positional location for the UE. By reducing the time needed for, and the number of these observations made by the UE, the embodiments conserve power and reduce the time needed to compute the position of the UE.

In a further alternate embodiment, the UE receiver may be implemented as an integrated circuit comprising a processor, a storage containing a stored program for causing the processor to perform the prioritization method, and a memory containing one or more stored lists of communication elements or cells that the UE maintains. These lists may include CSG lists that the UE is a member of, recently heard or neighbor cell lists, lists of cells previously selected by the UE, lists of small area cells such as HeNBs, pico-eNBs, and the like. The UE, on receiving a request from the network, will perform instructions in the processor that cause the UE to prioritize the communication elements it will make RSTD measurements for based on one or more of these lists, and store the RSTD measurement results in the storage within the UE for reporting to the network.

An alternative embodiment of a UE used with the methods is to provide a UE containing a programmable processor, a program storage such as a non-volatile memory device, and additional storage in a memory such as a non volatile memory device, where these devices are formed of discrete integrated circuits. Executable instructions for the processor may be provided as software, firmware or even hard coded into the processor when it is manufactured as hardware instructions, to cause the UE to perform the methods for prioritizing the communication elements and making the observations, storing the RSTD measurements, and reporting the stored measurements to the network.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawing, in which:

FIG. 1 illustrates a communications system according to an advantageous embodiment of the present invention;

FIG. 2 illustrates user equipment communicating to an eNode B over an air interface, and an E-UTRAN communications system according to an advantageous embodiment of the present invention;

FIG. 3 illustrates a block diagram of a communication terminal according to an advantageous embodiment of the present invention;

FIG. 4 illustrates communication layers of a UE, eNB and MME according to an advantageous embodiment of the present invention;

FIG. 5 illustrates the use of a known multilateral location technique to locate a device based on observed time of arrival differences in signals transmitted by fixed location stations;

FIG. 6 illustrates a cellular device such as a UE communicating over an air interface to a base station or eNB;

FIG. 7 illustrates a cellular device such as a UE communicating over an air interface to a Home eNB;

FIG. 8 illustrates a flow chart for an exemplary method embodiment.

FIG. 9 illustrates a flow chart for an alternative exemplary embodiment; and

FIG. 10 illustrates a flow chart for another alternative exemplary embodiment.

### DETAILED DESCRIPTION

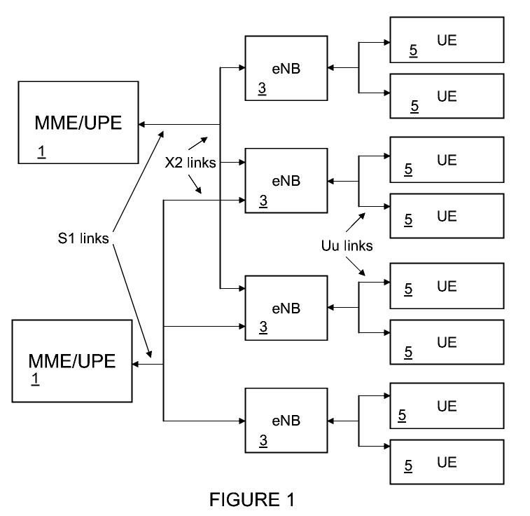

Referring initially to FIG. 1, illustrated is a system level diagram of a radio frequency interface communication system including a wireless or air interface (AI) communication system that provides an environment for the application of the principles of the present invention. The wireless communication system may be configured to provide features included in the E-UTRAN services. Mobile management entities (“MMEs”) 1 and user plane entities (“UPEs”) provide control functionality for one or more E-UTRAN node Bs 3 (alternatively referred to as base stations) via an S1 interface or communication link. The base stations 3 communicate via an X2 interface or communication link. The various communication links are typically fiber, microwave, or other high-frequency metallic communication paths such as coaxial links, or combinations thereof.

The base stations 3 communicate over the AI with user equipment 5 (designated “UE”), each of which is typically a mobile transceiver carried by a user. Alternatively, the user equipment may be a mobile web browser, text messaging appliance, a laptop with a mobile PC modem, or other user device configured for cellular or mobile services. Thus, communication links (designated “Uu” communication links) coupling the base stations 3 to the UEs 5 are AI links employing a wireless communication signal. For example, the devices may communicate using a known signaling approach such as a 1.8 GHz orthogonal frequency division multiplex (“OFDM”) signal. Other radio frequency signals may be used.

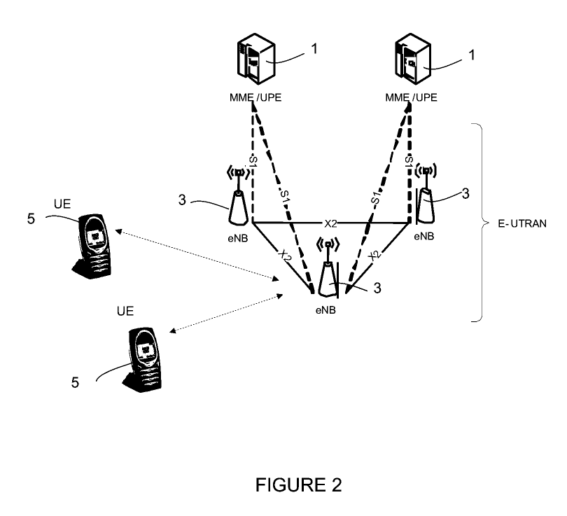

FIG. 2 illustrates in a system level diagram a communication system including a wireless communication system that provides an environment for the application of the principles of the present invention. The wireless communication system provides an E-UTRAN architecture including base stations 3 providing E-UTRAN user plane (packet data convergence protocol/radio link control/media access control/physical transport) and control plane (radio resource control) protocol terminations directed towards UEs 5. The base stations 3 are interconnected with an X2 interface or communication link. The base stations 3 are also connected by an S1 interface or communication link to an evolved packet core (“EPC”) including, for instance, a mobility management entity (“MME”) and a user plane entity (“UPE”) 1, which may form an access gateway (“aGW”). The S1 interface supports a multiple entity relationship between the mobility management entities/user plane entities and the base stations and supports a functional split between the mobility management entities and the user plane entities.

The base stations 3 may host functions such as radio resource management (e.g., internet protocol (“IP”), header compression and encryption of user data streams, ciphering of user data streams, radio bearer control, radio admission control, connection mobility control, and dynamic allocation of resources to user equipment in both the uplink and the downlink), selection of a mobility management entity at the user equipment attachment, routing of user plane data towards the user plane entity, scheduling and transmission of paging messages (originated from the mobility management entity 1), scheduling and transmission of broadcast information (originated from the mobility management entity or operations and maintenance), and measurement and reporting configuration for mobility and scheduling. The mobility management entity/user plane entity 1 may host functions such as distribution of paging messages to the base stations, security control, terminating user plane (“U-plane”) packets for paging reasons, switching of U-plane for support of the user equipment mobility, idle state mobility control, and system architecture evolution bearer control. The user equipment receives an allocation of a group of information blocks from the base stations.

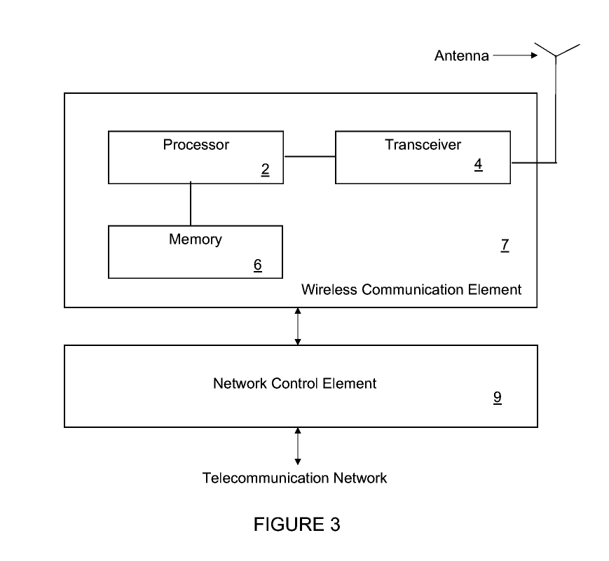

FIG. 3 illustrates a simplified system level diagram of an example communication element of a communication system that provides an environment and structure for application of the principles of the present invention. The communication element 7 may represent, without limitation, an apparatus including a base station or NB, UE such as a terminal or mobile station. The communication element includes, at least, a processor 2, memory 6 that stores programs and data of a temporary or more permanent nature, an antenna, and a radio frequency transceiver 4 coupled to the antenna and the processor for bidirectional wireless communication. Other functions may also be provided. The communication element may provide point-to-point and/or point-to-multipoint communication services.

The communication element 7, such as a base station in a cellular network, may be coupled to a network element 9, such as a network control element of a telecommunication network. The network control element 9 may, in turn, be formed with a processor, memory, and other electronic elements (not shown). The network control element 9 generally provides access to a telecommunication network such as a public switched telecommunication network (“PSTN”). Access may be provided using fiber optic, coaxial, twisted pair, microwave communication, or similar communication links coupled to an appropriate link-terminating element. A communication element 7 formed as a mobile station is generally a self-contained device intended to be carried by an end user; however in areas where wired services are not available the mobile station may be permanently installed at a fixed location as well.

The processor 2 in the communication element 7, which may be implemented with one or a plurality of processing devices, performs functions associated with its operation including, without limitation, encoding and decoding of individual bits forming a communication message, formatting of information, and overall control of the communication element, including processes related to management of resources. Exemplary functions related to management of resources include, without limitation, hardware installation, traffic management, performance data analysis, tracking of end users and mobile stations, configuration management, end user administration, management of the mobile station, management of tariffs, subscriptions, and billing, and the like. The execution of all or portions of particular functions or processes related to management of resources may be performed in equipment separate from and/or coupled to the communication element, with the results of such functions or processes communicated for execution to the communication element. The processor 2 of the communication element 7 may be of any type suitable to the local application environment, and may include one or more of general-purpose computers, special-purpose computers, microprocessors, digital signal processors (“DSPs”), and processors based on a multi-core processor architecture, as non-limiting examples.

The transceiver 4 of the communication element 7 modulates information onto a carrier waveform for transmission by the communication element via the antenna to another communication element. The transceiver 4 demodulates information received via the antenna for further processing by other communication elements.

The memory 6 of the communication element 7, as introduced above, may be of any type suitable to the local application environment, and may be implemented using any suitable volatile or non-volatile data storage technology, such as a semiconductor-based memory device, a magnetic memory device and system, an optical memory device and system, fixed memory, and removable memory. The programs stored in the memory 6 may include program instructions that, when executed by an associated processor 2, enable the communication element 7 to perform tasks as described herein. Exemplary embodiments of the system, subsystems, and modules as described herein may be implemented, at least in part, by computer software executable by processors of, for instance, the mobile station and the base station, or by hardware, or by combinations thereof. Other programming may be used such as firmware and/or state machines. As will become more apparent, systems, subsystems and modules may be embodied in the communication element 7 as illustrated and described above.

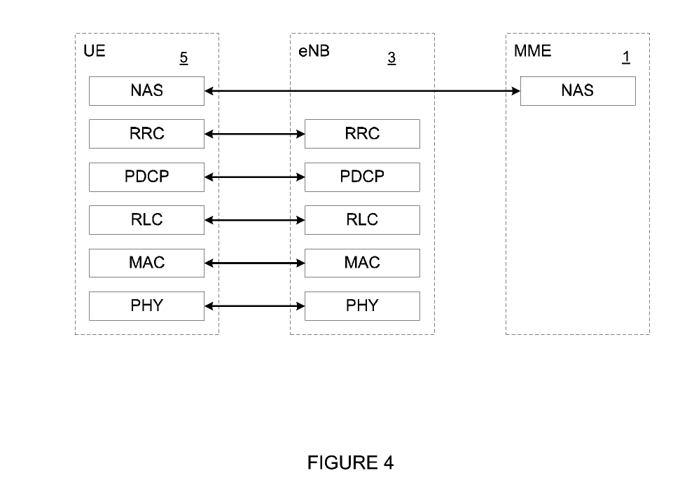

FIG. 4 depicts a block diagram of an embodiment of user equipment 5 and a base station 3 constructed according to the principles of the present invention. The user equipment UE 5 and the base station eNB 3 each include a variety of layers and subsystems: the physical layer (“PHY”) subsystem, a medium access control layer (“MAC”) subsystem, a radio link control layer (“RLC”) subsystem, a packet data convergence protocol layer (“PDCP”) subsystem, and a radio resource control layer (“RRC”) subsystem. Additionally, the user equipment 5 and the mobile management entity (“MME”) 1 include a non-access stratum (“NAS”) subsystem.

The physical layer subsystem supports the physical transport of packets over the LTE air interface and provides, as non-limiting examples, CRC insertion (e.g., a 24 bit CRC is a baseline for physical downlink shared channel (“PDSCH”)), channel coding, hybrid asynchronous retransmit request (“HARQ”) processing, and channel interleaving. The physical layer subsystem also performs scrambling such as transport-channel specific scrambling on a downlink-shared channel (“DL-SCH”), broadcast channel (“BCH”) and paging channel (“PCH”), as well as closed multicast channel (“MCH”) scrambling for all cells involved in a specific multimedia broadcast multicast service single frequency network (“MBSFN”) transmission. The physical layer subsystem also performs signal modulation such as QPSK, 16 QAM and 64 QAM, layer mapping and pre-coding, and mapping to assigned resources and antenna ports. The media access layer or MAC performs the HARQ functionality and other important functions between the logical transport layer, or Level 2, and the physical transport layer, or Level 1.

Each layer is implemented in the system and may be implemented in a variety of ways. A layer such as the PHY in the UE 5 may be implemented using hardware, software, programmable hardware, firmware, or a combination of these as is known in the art. Programmable devices such as DSPs, reduced instruction set (“RISC”), complete instruction set (“CISC”), microprocessors, microcontrollers, and the like may be used to perform the functions of a layer. Reusable design cores or macros as are provided by vendors as ASIC library functions, for example, may be created to provide some or all of the functions and these may be qualified with various semiconductor foundry providers to make design of new UEs, or eNode B implementations, faster and easier to perform in the design and commercial production of new devices.

Requirements are now in place and further being developed for wireless systems that require the carriers to provide emergency enhanced 911 or “e911” service, for example in the United States, for persons using cellphones. Recent studies suggest that approximately half of the emergency 911 calls made in the United States originate from mobile cellphones or UEs. Current FCC requirements are that an emergency call received from a UE on the E911 service must locate the call to within 50 meters for 67% of the calls, and to within 150 meters for 95% of the calls. These requirements are available at the internet website at URL www.fcc.gov. In developing the 3GPP standards, a working item on UE positioning was agreed to in the document numbered RP-080995, Work Item, entitled “Positioning Support for LTE”; TS-RAN#42, Qualcomm, December 2008, which is hereby incorporated herein in its entirety by reference.

A problem with performing location of the UE using wireless services is that the network eNBs, such as base stations, are not aware of exactly where the UE is physically located. The network or eNBs may know the UE is within range of their signal, but that can be a very large area. For example, the network controller may know which eNB the UE is currently communicating with, that is the eNB the UE has selected or is “camped” on. However, the network is not able to know which eNBs are available to the UE (that is, the eNB does not know which base stations the UE can “hear”) without the UE first performing some observations and reporting back to the network. In some cases the number of eNBs the UE can “hear” may be quite large so that the number of possible received signal observations can be excessively large. For the UE to perform all of these signal observations is a computational burden, causes additional power consumption in the battery powered UE, and may take more time to perform than the requirements for performing the emergency location services allow or provide.

To implement a system that can provide emergency wireless 911 services, one of the methods for positioning cellphones that has been proposed is the use of multilateration (sometimes called hyperbolic positioning) using observed time difference of arrival (OTDOA). In this approach, the UE listens for a reference signal from multiple stations that have known locations and records the different times of arrival relative to a known time base. This information can then be retrieved by the network and used to compute the location of the UE.

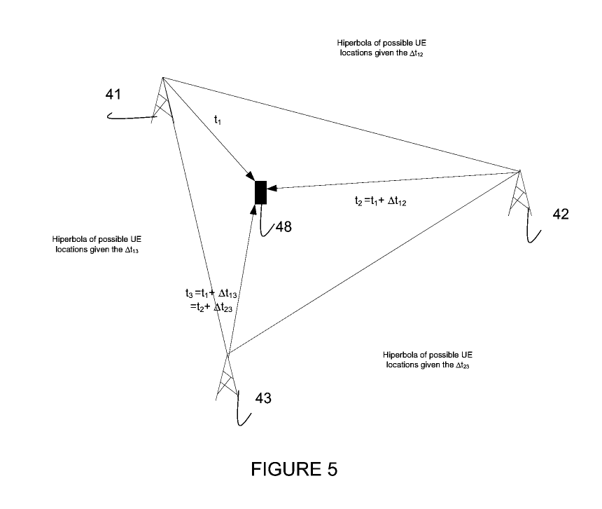

FIG. 5 depicts how multilateration can be used to locate a receiver. In FIG. 5, receiver UE 48 is shown and three eNB or base stations 41, 42, and 43 are pictured transmitting over the air, or radio, signals. For each base station, a signal is received. For example, UE 48 receives the signal from station 41 at time “t₁”. Similarly it receives the signal from station 42 at time “t₂”. Finally it receives the signal from station 43 at time “t₃”.

Also shown are the relationships that may be derived between the times. Time t₂=t₁+Δt₁₂, where Δt₁₂ is the difference between the time of arrival observed for t2 and t1. Similarly, time t3 is related to both times t₁ and t₂, to t₁ as t₁+Δt₁₃, and to t2 as t₂+Δt₂₃. Each observation measured by the UE gives a hyperbolic curve of possible locations for the receiver with respect to the position of the base station. When there are at least three stations for which the received signal time of arrival is observed, a location for the UE may be provided at the intersection of the three hyperbolic curves, as shown in FIG. 5. As more time observations from additional known locations are added the location information may be refined or become more precise. However, for locating a UE such as a mobile phone device, 3 to 5 stations that can be clearly received or “heard” by the mobile are sufficient to provide a location.

As is known to those skilled in the art, the UE can store these measurements as “received signal time difference” (“RSTD”) measurements. The method or methods used to perform a single RSTD measurement for return to the network is considered known to a person skilled in art. The methods used to perform the RSTD—measurement may include, for example, producing cross correlation results of a received signal and the positioning reference signal (PRS), and detecting the received signal time difference from the correlation results.

The current known approaches to using OTDOA observations by the UE to provide the network enough information to perform a location computation are time and resource prohibitive. As a simple approach, the UE could act with no information about when to listen for signals from the eNBs, a so-called “blind decoding” approach. A blind decoding could be used but because, in such a case, the UE may not know when and at what frequency to listen for the pilot signals, it appears that this approach is not practical, the time provided for the location computation would be insufficient. A network assisted approach is therefore proposed to be adopted where, when the UE is sent a request from the network to perform the observations, the network also provides information about the eNBs, including the frequency and time parameters needed to assist the UE in listening to the eNBs. The 3GPP document numbered R1-093729, entitled “LS assistance information for OTDOA position support for LTE”, from RAN1 to RAN2 and RAN4, Ericsson, 2009, describes this approach and this document is hereby incorporated by reference herein in its entirety. This approach provides a faster OTDOA procedure than simply relying on a blind decoding approach.

However, the network does not know, specifically, which eNBs the UE can actually reliably detect, or hear. The set of assistance information provided by the network is necessary to allow the UE to find a signal for making the observations. The information is dependent on many different parameters and this leads to a very large set of different signals configurations. Further the reference signals are transmitted very seldom and if the UE did not have the network provided assistance information, the times these signals are transmitted would be unknown to the UE. The network assistance data is meant to provide a list of possible cells the UE may hear, with their signaling parameters and a window of time in which the UE may hear the positioning signals being transmitted from them.

Because it is typically a mobile device, the UE is moving about. The network may only know which eNB the UE is “camped” on, and thus can only assume the UE is somewhere within the coverage of that cell area. However, that area may be quite large. To locate the device the network needs OTDOA from a number of eNBs. Current proposals are to provide a list of 24 or more eNBs that the UE is to make OTDOA observations for. This proposal is described at the document entitled Technical Specification (TS) 36.355 v. 2.2.0, “Positioning Protocol (LPP)”, provided at www.3gpp.org and which is hereby incorporated by reference herein.

Providing all of these cells on the network assistance list really may not be necessary, as only three to five good RSTD observations (3-5 stations the UE can clearly hear) may be sufficient for locating the UE. Further, because the observations need to happen in a short time period, the UE modem must disable its usual “sleep” mode and remain active throughout the observations, consuming UE battery power. Also, the computation may take much longer than needed if the UE is in fact very close to an eNB with a precisely known location; in which case observing the whole group of eNBs provided by the network assisted approach is wasteful of time and UE power; and power of course is especially important to a battery powered cellphone or UE.

The problems with the known approaches are described below in terms of an exemplary radio access technology or standard, for example, LTE. However the use of the methods and system embodiments described below is exemplary and made for increased understanding. The embodiments are not limited to any particular radio access technology (RAT), terminology, or wireless standard, for example LTE, E-UTRAN, LTE-A, 3G, 4G, etc.

Although OTDOA measurements from as few as 3-5 base stations may be sufficient to provide enough data for the multilateration location procedure to provide a position for the receiver, the network cannot know whether the UE is able to reliably detect or hear the Positioning Reference Signal (“PRS”) for a particular eNB cell. A UE can detect, or hear, signals from an eNB or cell when the signal to noise ratio (SNR) for signals transmitted by the eNB exceeds a certain threshold, and the PRS sequence is detected. Therefore, for reliable operation, in the current known approaches the network provides a bigger list of OTDOA neighbor cells than is actually needed for the UE to make RSTD measurements. The OTDOA neighbor cell list size, labeled “OTDOANeighbourCellInfoList”, currently under discussion consists of 24 cells. This list is not ordered or prioritized, which implies that the UE needs to determine by exhaustive PRS-based measurements eNBs or cells which are within reliable detection of the UE, or “hearable”. This approach is very inefficient from the UE's viewpoint, as it would significantly increase the processing requirements and also increase UE battery consumption. Battery consumption is a critical feature for portable devices such as UEs.

Further, given that the network or controller requesting the OTDOA procedure initially only knows very approximately the location or position of the UE based on the cell ID of its current serving cell (that is, the network knows the UE is somewhere within the coverage area of that cell, an area ranging from several hundreds of meters to a few kilometers), the search time window the network may signal to the UE to use in the search for the positioning signals is also quite a rough estimate. The search time may too long (far longer than needed). This increases the probability the procedure will take extra time. The time window is described in the document numbered R2-095773, “Text proposal for TS 36.355 OTDOA material’, from Qualcomm, October 2009, which is incorporated herein in its entirety by reference.

Embodiments of the present invention address these issues and provide efficient and simple methods to perform the needed observed time difference signal observations using less power, less time, and fewer system and UE resources. The methods may then continue to perform the hyperbolic receiver location procedure using the observations provided by the embodiments of the invention.

In a first method embodiment, on receiving a request to make the ODTOA observations, the UE prioritizes the cells or eNBs it will make RSTD observations for. In the first embodiment, the priority scheme may take advantage of the list of neighbor cells that the UE already maintains for mobility purposes. This information may be stored, for example, in memory within the UE such as non-volatile or FLASH memory, dynamic memory, on-board or embedded memory within a processor, and the like.

In order to operate correctly as a mobile device, the UE constantly listens for and identifies eNBs that it can receive/transmit to in order to enable the proper “hand off” to the next eNB as the UE moves about (mobility). A UE typically is in communication with a serving cell that is selected through a selection procedure. As the UE continues to move about within the serving cell area, the UE constantly maintains a list such as an internal “neighbors” list. The list is frequently updated. The information on the list may include, for example a cell ID field, power level observed, signal timings observed, and time stamp information such as how long ago the pilot signal from this cell was received or “heard” by the UE.

As the current selected eNB signal gets weaker near the edge of a selected cell, or when shadowed by a building for example, the UE thus has already identified additional eNBs that it can request access to by performing a “reselection” process. In this manner, a cell phone user does not experience any loss of connection while using the UE in a car, train, or just walking around—the UE hand off to the next serving cell is performed without the user noticing and with no loss of service.

The stored list within the UE may include different kinds of eNB cells. For example it may include “home eNB” (“HeNB”) cells. It may include so called “pico-eNB” cells. These may be used in an office or campus environment or at a mall, for example. It may include Closed Subscriber Group (CSG) cells of which the eNB is a subscriber, such as a home or office CSG. All of these fields may be stored locally in the UE memory.

In the present embodiment, the stored list of neighboring eNBs is also used to prioritize the OTDOA observations that the UE will make in order to provide the network with the RSTD measurement data needed to perform the multilateration procedure to locate the UE for e911 services.

When an OTDOA measurement request is received by the UE, with the assistance data, the UE can use this internal neighbor list to:
Prioritize the cells that the UE is aware are, or were recently, hearable.
Assuming the network knows the positions of the relatively smaller cells in the CSG list, the UE may give these smaller cells the highest priority for making observations of the RSTD measurements.
The UE may search the positioning reference signal by using a time search window around the already detected timing, which has been stored in the neighbor list during the mobility measurements. (In this case the length of the search window can be considerably smaller as compared to a prior art case in which the PRS signals are searched from the eNBs without utilizing the detected timing information on the neighbor list).
With respect to eNBs on the neighbors list, the UE needs to make additional positioning observations only to fine tune the existing mobility measurements.
   This is needed because the positioning timing measurements require more accurate timing (Ts resolution) than the mobility measurements (16 Ts resolutions).

By using the stored lists already stored by the UE, such as the neighbor lists for mobility, CSG lists, previously selected cell lists, and other stored lists to prioritize the cells to be listened to in making the OTDOA measurements, the amount of time and resources spent on the measurements can be reduced—thus reducing the UE power consumption expended during the positioning procedure. The UE may start, for example, from cells that are prioritized based on the use of one or more of these stored lists, and if the observation measurements are sufficiently good for a few cells, the procedure can rapidly provide the UE location without the need for an exhaustive measurement for each cell on a longer, network provided, list.

Explanatory details of implementing a method embodiment are now provided and described in the context of the LTE standards. However, the embodiments are not limited to a particular example system or standard, the terminology used, such as the names of fields etc. are exemplary, not limiting, and the embodiments may be extended to any mobile device that communicates in a cellular network.

Presently, a field is defined as the “Information Element Measured Object EUTRA” that specifies information applicable for intra-frequency or inter-frequency E-UTRA neighboring cells. This field includes the neighbor cell list for mobility measurements. This field is signaled to the UE by the eNB, for example, by using higher layer signaling. On receiving this signal, the UE makes measurements from the cell specific reference signals (“CRS”) transmitted by the eNBs for the cells that are on the list. The UE stores the measurement results in an internal neighbor cell list in UE memory. These stored measurements are used by the UE for reporting to the requesting controller or the network in a signal or field called “IEMeasResults”. This field covers measured results for inter-frequency, intra-frequency and inter-RAT mobility.

Each entry in the internal neighbor cell list may contain, for example:
Cell ID that was heard, including Cell IDs in the CSG list;
timing where the cell was heard (that is, relative reception strength of this cell compared to the serving cell, the time difference is due to the different transmit timing and the distance to the cell);
power with which it was last heard; and
the last time the cell was heard.

In one exemplary embodiment, the cells that are located in both the network provided assistance information list that accompanies the request to make the OTDOA measurements, and the internal neighbor list stored in the UE, may be given priority for RSTD measurements over cells that are not in both lists. In another embodiment, the highest priority may be given to the cells that are also in the CSG list, which is another list that may be stored by the UE internally.

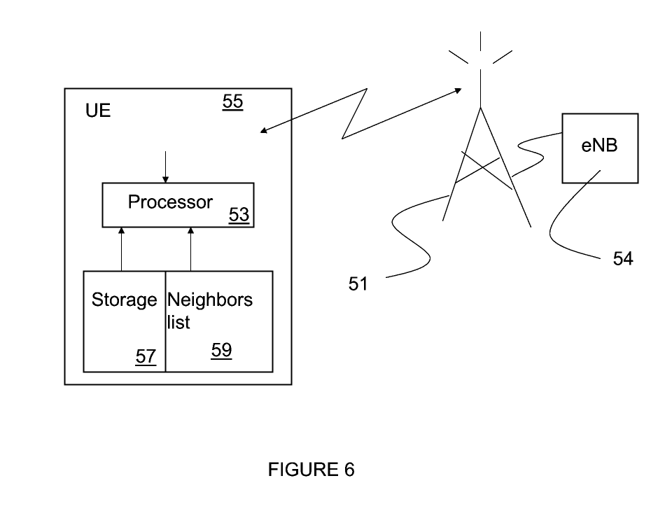

FIG. 6 illustrates a UE 55 communicating with an eNB 54 using antenna 51, the UE 55 having a processor 53, on board memory for instructions and data 57, and an internal memory 59 for storing the neighbors list, which could include, for example, a CSG list, whitelist, or other list of cell IDs the UE has located, selected, camped on previously, or heard. The UE 55 may, depending on the embodiment method selected, perform a prioritization for selecting cells to perform the OTDOA measurements as described above using, for example, program code stored in the storage memory 57 as executable instructions for processor 53.

In another particular embodiment, for a UE that is compatible with LTE Release 8, if the UE is “camped” on a suitable CSG cell, in the current standards the UE is to always consider the current E-UTRAN frequency to be the highest priority frequency in the cell priorities handling. That means this frequency is to be considered a higher priority than the eight network configured values, irrespective of any other priority value allocated to this frequency. This is described in the document entitled “TS 36.304, V 8.7.0, E-UTRA User Equipment (UE) Procedures in Idle Mode”, available at www.3gpp.org; which is hereby incorporated by reference herein. Similarly, in an embodiment of the present methods the UE will give highest priority to the CSG cells for the RSTD measurements needed for emergency location.

In another embodiment, additional consideration is given to whether the UE can hear smaller cells, such as private Home-eNB cells, and pico-eNB cells. A flag set in the “csg-information” field in a resource called the “System Information Block 1” or SIB1 indicates whether the cell is private. This field is described in the document entitled “TS 36.361, V 8.7.0, E-UTRA Radio Resource Control”, available at www.3gpp.org; which is hereby incorporated by reference herein. If this flag is true, for example, the UE can only access the cell if the CSG identity matches an entry in the allowed CSG list stored in the UE. (This list is sometimes called a “whitelist”). However, current LTE specifications do not prevent the UE from making the RSTD measurements by hearing the CRS signals from a cell and making observations based on measurement from cells, even if the CSG identity is not included in the allowed CSG list. This approach would therefore be backwards compatible with existing Rel. 8 standard compliant LTE equipment.

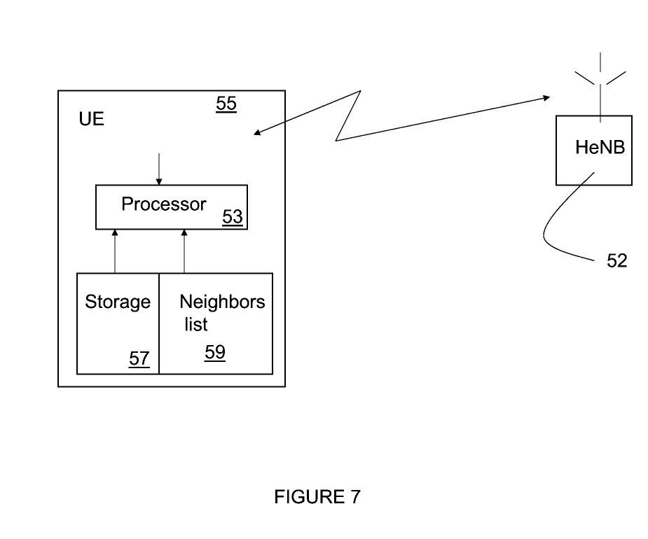

FIG. 7 illustrates, for example, a UE 55 as in FIG. 6 but camped on a home eNB cell HeNB 52. The UE could implement a modified observation measurement where the identity of the HeNB cell is stored and transmitted to the network while the OTDOA measurements begin, or even before the OTDOA measurements are made or completed, because the location of the UE is very close to the known location of the HeNB; thus performing the multilateration procedure to locate the UE may not be needed at all. That is, the coverage area of these HeNB, femtocells or pico-eNBs is very small; a UE that has selected such a cell is within a small physical area around the location of that cell. Alternatively the RSTD observations could focus on the HeNB and cells that have stronger SNR or signal quality in relation to it, and only a couple of additional observations may be needed to provide the network sufficient measurements to precisely locate the UE.

A modification to the UE may be implemented, for example, the UE may get the information “Physical Cell ID (PCID)” in the “Information Element Measured Object EUTRA”:

| | | |
|---|---|---|
| CellsToAddMod | ::= | SEQUENCE { |

| | |
|---|---|
| cellIndex | INTEGER (1..maxCellMeas), |
| physCellId | PhysCellId, |
| cellIndividualOffset | Q-OffsetRange |

This is an example of one way to implement the methods presented for illustration, but the embodiments are not limited to E-UTRA or LTE compliant equipment and other approaches may be used.

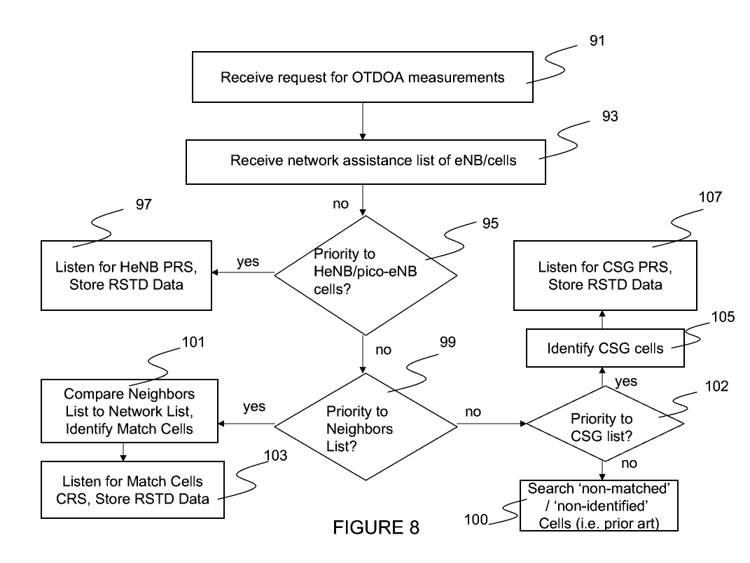

FIG. 8 depicts in a simple flow chart one possible, non-limiting, example implementation of the priority schemes for the UE to perform the methods of the embodiments. In FIG. 8, in state 91, a UE receives a request to perform the OTDOA measurements needed by the network to perform a procedure such as multilateration, to locate the UE. In state 93, the UE also receives the network provided assistance list of eNBs or cells that the UE may listen for. In state 95, a decision is made. In one exemplary embodiment, the UE may be configured to prioritize the measurements based on small area cells such as HeNB/pico-eNB cells. As shown in the figure, however this is optional. If the UE is configured to prioritize the measurements for small area cells such as HeNB, pico-eNB cells, it transitions to state 97. In state 97, the UE listens for the PRS signals and stores the received signal time difference (RSTD) data. (For simplicity in this illustration, in state 97 the method also determines if the measurements made are sufficient for the location procedure. If the number of RSTD measurement results is not enough for the eNB to define the position of UE, the UE transitions to state 99. If the number of RSTD measurement results is enough the UE will signal the measurement results to the eNB, and the OTDOA measurements are completed.)

If the scheme used for prioritizing the OTDOA measurements is not configured to prioritize the HeNB cells, or the scheme used for prioritizing the OTDOA measurements is to prioritize the HeNB cells and the number of RSTD measurement results is not enough for eNB to define the position of the UE, the UE transitions to state 99. In state 99 another decision is made, this one is based on whether the UE is configured to prioritize the measurements using the neighbors list. If the decision outcome is “yes”, the UE transitions to state 101, and the UE may compare the neighbors list to the network provided assistance list. The cell IDs that are on both lists are prioritized, and the UE then makes RSTD measurements for those cells and stores the data. The priority characteristics may include stored characteristics such as transmit power, most recently heard, received signal quality, time since last heard, and the like. The state diagram then transitions to state 103, where the RSTD measurements for the cells on the match list are made. Again, although not shown for simplicity, if after the RSTD measurements are made in state 103, the number of RSTD measurement results is not enough for the eNB to define the position of UE, the state diagram transitions to state 99 otherwise the UE will signal the measurement results to eNB and the OTDOA measurement request is completed.

If in decision state 99 the UE transitions to state 102, the CSG list of cells may be given priority, and in state 105 the UE identifies the CSG cells. In state 107 the UE will perform RSTD measurements on those cells and store the data. Again, although not shown in detail for simplicity, if the number of RSTD measurement results is not enough for the eNB to define the position of UE, the UE will then perform the “prior art” approach in state 100, that is, use the entire list of cells provided by the network and complete the OTDOA measurements in an exhaustive approach. Otherwise, and preferably if the RSTD measurements include 3 to 6 reliable measurements, enough for the location procedure, then in state 107 the UE will signal the measurement results to eNB and the OTDOA measurement request is completed.

If, in state 102, the CSG list is not to be given priority so that the decision is no, the transition of the state diagram is to state 100, where the prior art approach is used to measure OTDOA for all of the cells on the network list, and the RSTD data are stored for reporting to the eNB.

The flow chart of FIG. 8 is only one example flow diagram, as described below others may be used, the state numbers and order of steps is explanatory and the claims and the embodiments are not to be limited by the examples shown in FIG. 8, the order of the steps may be changed, some steps may be omitted, and these alternatives are considered additional alternative embodiments contemplated as part of the present invention. Other priority schemes using stored cell information could also be used. States may be combined or skipped as alternative method embodiments. The use of the flow diagrams presented here does not limit the implementation of the embodiments, state machines, programmable processors, microcontrollers, microcode, dedicated logic or other hardware and software implementations may be used to cause the UE to perform one or more of the method embodiments.

In case the standards are changed in the future, an embodiment method may be used where the UE does not have to measure all of the signaled cells (from the network assistance message) but only enough to find some (e.g. 3-5) good ones. In this manner the UE can still further limit the time spent making the observations.

In case the UE does not have time enough to measure all of the cells on the network provided list, the measurements significance for the prioritized cells would be bigger, these are cells for which the probability of detecting the PRS signals with sufficient SNR and reception quality is higher and therefore the RSTD measurements for these cells would be the most important for the location procedure.

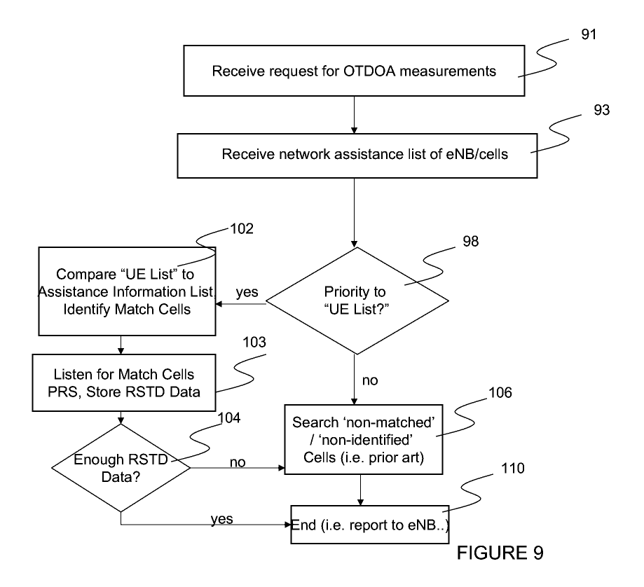

Another example flow diagram is presented in FIG. 9. In FIG. 9, the flow diagram begins in state 91 as before, the UE receives a request for OTDOA measurements. In state 93 the UE also receives a network assistance list of eNB/Cells. In state 98 a decision is made on whether to give priority to the UE List, which is a stored list of any variety the UE keeps track of, the neighbors list, for example, or a CSG list, or some other list of stored cells. In state 102, the flow diagram shows the UE performing a comparison to identify cells on both lists by matching them. In state 103, the UE gathers data by performing measurements on the cells in the match list and storing RSTD data. In state 104, a decision is made. If the UE has enough data, the UE transitions to state 110 and reports the RSTD data to the eNB and the measurements are complete. If there is not sufficient RSTD data, the state diagram shows the UE transitions to state 106, where the UE performs the prior art approach, using all of the cells remaining on the “network assistance list” and then transitions to state 110. Note that if the decision in state 98 is a “no”, the UE does not perform the matching process in state 102 but instead transitions to state 106 and performs the prior art approach. By using a programmable processor in the UE and providing instructions, or by passing a configuration to the UE with the request for the OTDOA measurements, the network can then selectively configure the UE to use the priority scheme of the exemplary embodiments, or to perform the prior art approach directly. Different combinations of the methods are therefore easily obtained and the use of the embodiments of the present invention may be enabled or disabled using simple communications, passing parameters, providing a macro or subroutine to the UE, or using other known programming techniques.

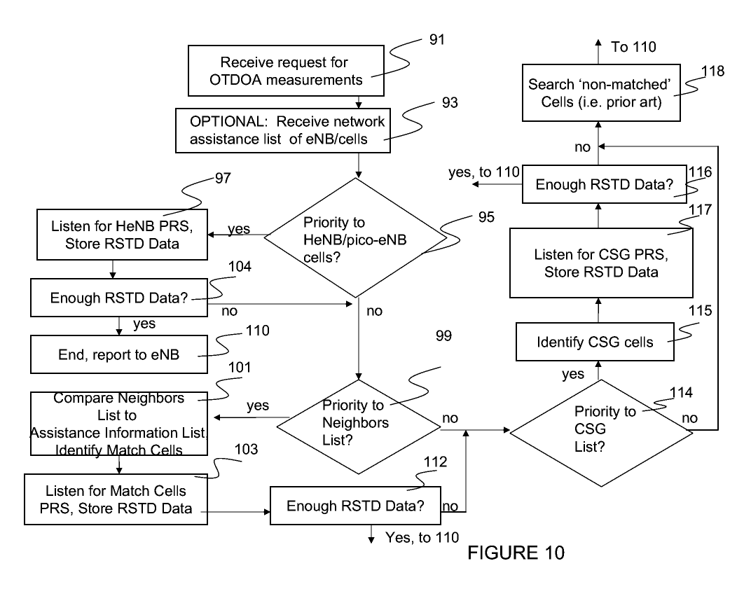

FIG. 10 depicts in another flow diagram, illustrating a more complex embodiment. This alternative embodiment combines several priority schemes but is not limited to any one of them or to all of them; the UE may be selectively configured to perform all of the steps, or some of the steps, of FIG. 10.

In FIG. 10, the UE again first receives a request to perform the OTDOA measurements in state 91. Then in state 93 the UE may optionally receive a network assistance list. However, the standards may be altered in the future so that the UE does not have to receive this list from the network, it may be described as an optional message.

In state 95, again, a decision is made as to whether the UE is configured to prioritize the small cells such as HeNB and pico-eNB cells for the UE measurements. If the answer is yes, the state diagram transitions to state 97, where the UE listens for the PRS signals for these cells and stores the RSTD data. In state 104 the UE determines whether enough RSTD data was collected for the location procedure. If so, the state diagram transitions to state 110 and the UE reports the results to the eNB, and the measurements are complete.

Returning to state 95, if the decision was no, then the state diagram shows a transition to state 99, where a decision is made. In state 99, it is determined whether the UE is configured to prioritize the “neighbors list” for the measurements. If the decision is yes, the state diagram transitions to state 101, where the UE performs a comparison to identify the cells on both lists. In a case where the network assistance list is not received in state 93, the UE just identifies the cells on its stored neighbors list. The state diagram next transitions to state 103, where the UE listens for the match cells PRS signals, and stores RSTD data. In state 112, again the UE determines whether there is enough data for the location procedure. If so, the UE again transitions to state 110, and ends the measurements. If not, the UE transitions to state 114.

Returning to state 99, if the decision was no, then the UE also transitions to state 114. In state 114 another decision is made. A determination is made on whether the UE is configured to prioritize the CSG list for the measurements. If the decision is yes, the state diagram shows a transition to state 115, where these cells are identified. In state 117, the UE listens for the PRS signals and stores the RSTD data. In state 116, the UE determines whether there is sufficient RSTD data stored, if so, the UE transitions to state 110. If not the UE transitions to state 118.

In state 118, the UE performs the prior art approach and measures the remaining cells on the network assistance list. Once this exhaustive OTDOA measurement of the PRS signals is made, the UE transitions to state 110 and reports the RSTD stored data to the network.

Note that in this flow diagram, after each measurement type is made, the UE determines whether enough RSTD data has been collected and if not, the UE performs another measurement. Also if a particular priority scheme is not selectively enabled, the state diagram shows that another scheme is evaluated and if it is not enabled, eventually the state diagram leads to state 118, where the prior art measurement scheme is performed. Thus, the flow diagram always leads to a state where the RSTD measurements needed for the location procedure are performed and in sufficient number for the network to use for location.

The use of the embodiments can provide relatively higher positioning accuracy, and complete the location procedure in a shorter time, than the known approaches of the prior art. By setting the time search window for the UE OTDOA observations to a smaller time search window centered around the already detected timing observed during the UE mobility measurements, the search window may be made smaller and the time and resources needed to make the measurements may be reduced.

Additional embodiments may be used. Because HeNB and other small area cells such as pico-eNB cells typically provide small coverage areas, when a UE is hearing such a cell, making RSTD observations may have only marginal impact on the accuracy of the OTDOA positioning. Assuming the network has a physical location for the HeNB or pico-eNB cell, the small time search window for the procedure may be set to a much smaller window around the already stored mobility measurements.

As another alternative exemplary method embodiment, it may be assumed that the network knows the physical location of the these small cells and that the UE, if it is hearing these cells, is within a few meters, perhaps 10 meters of a home eNB, and perhaps 100 meters of a pico eNB, of that location. The RSTD measurement error can then be assumed to place the UE within similar range to these cells, which may act as anchors for OTDOA positioning. This means that in performing the RSTD measurements, the UE can give these cells the highest priority. If this information is sufficient the UE may not need to perform additional RSTD measurements before the location procedure is performed.

In a case where the UE RSTD measurements of PRS does not provide measurements with sufficiently high confidence, then for these smaller cells the network could decide to place the UE location at the HeNB location; because the E911 requirements would still be met (66% of UEs located within 50 meters, 98% within 150 meters, as required accuracy).

For the network to know the location of these smaller cells, network synchronization may be performed. Because certain types of location procedures may not be available, additional synchronization may be performed. For example, GPS location information is not available in all installations, where an HeNB is installed indoors for example, GPS satellite reception is not possible. An over the air synchronization of an HeNB to a larger eNB cell has been proposed. In this approach, the HeNB is initially treated as a UE. Here, the HeNB behaves like a UE to achieve synchronization to the larger eNB (e.g. a micro/macro eNB) based on reference signals—i.e. initially the HeNB can detect the synchronization signals such as Primary Synchronization Channel (P-SCH) and Secondary Synchronization Channel (S-SCH), and then the Cell Specific Reference Signal (CRS) may be used for the tracking of the time and frequency synchronization parameters. The CRS may be detected by the HeNB when it is idle, i.e., during the guard period in the special timeslot in LTE TDD; or during some blank subframes in LTE FDD. In this manner, the location of the HeNB may be established.

Thus, in some embodiments the UE, on receiving a signal to perform observations to provide the observed difference in time of arrival of signals for multilateration, may prioritize the cells to be observed based on a list of stored cells. The list may be, for example the neighbors list used for mobility, a CSG list, a list of CSG approved cells or any other list stored by the UE of previously selected, received or heard, cells. The list may include small cells such as HeNB or pico-cells. A network assistance message may indicate cells the UE is to listen to for signals. In one embodiment the UE identifies as higher priority the cells that are on both this network assistance list and an internal neighbors list, CSG list or other internally stored list. In other embodiments the UE may prioritize the small area cells such a HeNB and pico-eNB cells that are on the network or on a stored list.

The use of the embodiments has several advantages over the known approaches. The use of the exemplary embodiments will reduce the amount of power used, computations performed and time used by the UE to perform the OTDOA procedure. Further, because the UE refers to a list already stored internally within the UE, no additional signaling is needed, and the methods are compatible with Rel. 8 signaling, so the network need not be modified to implement the embodiments. The UE may be modified using software, additional hardware, or a combination of these. In a system where some UEs have implemented the embodiments described above, and others do not, the different equipment can still interoperate. That is, while the older UEs may not attain the advantages of the use of the embodiments, the system will not be impaired—other than the need for additional time and power to perform the ODTOA measurements.

In an illustrative method embodiment, a UE maintains a stored list of communication elements recently heard and/or recently used. On receiving a request to perform ODTOA measurement, the UE prioritizes the communication elements, such as cells, and performs the measurements on the cells with the highest priority. The priority scheme may be based on a selection scheme such as the most recently used cells, cells with the strongest signals, cells that the UE has used, small area cells such as home eNB and pico eNB cells. The UE stores the measurements.

In another illustrative embodiment, a method is provided for locating a mobile device such as a UE in a wireless network. The network will send a request to the UE to make ODTOA measurements on a list of communication elements having known locations. On receiving a request to perform ODTOA measurement, the UE prioritizes the communication elements and performs the measurements on the communication elements, such as cells, with the highest priority. The priority scheme may any one of several, including without limitation, prioritizing the most recently used cells, cells with strongest signals, cells that the UE has selected, cells on a CSG whitelist, small area cells such as home eNB and pico eNB cells. The UE stores the observed RSTD measurements. These measurements are then returned to, or retrieved by, the network. Using multilateration on at least three of these cells, the network can compute the physical location of the UE.

In another illustrative embodiment, a UE receiving a request to perform ODTOA measurements may determine that it is already attached to, or within range of, a very small cell such as HeNB or pico-cell. The UE may report this information to the network. If the network knows the location of the small cell with sufficient confidence, the location of the UE may be accurately known without the need for further measurements. Alternatively a few OTDOA measurements may then be made to further refine the physical location of the UE.

Embodiments of the present invention provide an efficient, fast and power conserving implementation of the user equipment location procedures needed for enhanced emergency services such as E911. Other applications where location of the UE is needed may also benefit from the embodiments of the invention.

In an embodiment the UE includes a processor, internal memory and program memory containing instructions that when executed, will cause the UE to perform a method comprising on receiving a request to perform ODTOA measurement, the UE prioritizes the communication elements, such as cells, and performs the measurements on the cells with the highest priority. The priority scheme may be based on any one of several including, without limitation, prioritizing the most recently used cells, cells with strongest signals, cells that the UE has used, small area cells such as home eNB and pico eNB cells. The UE may store the measurements in internal memory. These measurements are then returned to the network. Using multilateration on at least three cells, the network can compute the physical location of the UE.

In another embodiment, the UE may include an integrated circuit such as an ASIC that is designed to perform a method comprising, for example, receiving a request to perform ODTOA measurement, the UE prioritizes the cells and performs the measurements on the cells with the highest priority. The priority scheme may be based on most recently used cells, cells with strongest signals, cells that the UE has used, small area cells such as home eNB and pico eNB cells. The UE may store the measurements in internal memory. These measurements are then returned to the network. Using multilateration on at least three cells, the network can compute the physical location of the UE.

Although many parts of this description describe, as non-limiting examples, the application of the embodiments to a receiver such as a UE, the embodiments also apply to and may be advantageously used in a transmitter or transceiver, such as a base station or eNB. These additional embodiments are contemplated as embodiments of the present invention and are within the scope of the invention as defined by the appended claims.

Although various embodiments of the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof, to advantageously coordinate allocation of resources for user equipment to be handed over from a source base station to a target base station without contention and without a need for sharing timing information therebetween, as described herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a processor; and
memory including computer program code;
said memory and said computer program code configured to, with said processor, cause said apparatus to perform at least the following:
receive a request over a communications resource to perform a received signal time difference (RSTD) measurement by monitoring communications signals from a plurality of communication elements;
determine a priority scheme for the communication elements for making RSTD measurements for selected ones of the plurality of communication elements;
measure a RSTD for at least one of the selected ones of the plurality of communication elements; and
store the measured RSTD in a memory.

2. The apparatus as recited in claim 1 wherein said memory and said computer program code are configured to, with said processor, cause said apparatus to transmit said measured RSTD over said communications resource.

3. The apparatus as recited in claim 1 wherein said memory and said computer program code are configured to, with said processor, cause said apparatus to measure an RSTD for at least three communication elements; store the measured RSTD for each of the at least three communication elements in the memory; and transmit the measured RSTD for each of the at least three communication elements over said communications resource.

4. The apparatus as recited in claim 1 wherein said memory and said computer program code are configured to, with said processor, cause said apparatus to determine said priority scheme by retrieving a stored list of communication elements from said memory.

5. The apparatus as recited in claim 1 wherein said memory and said computer program code are configured to, with said processor, cause said apparatus to determine said priority scheme by receiving a list of communication elements on said communications resource, compare said received list to a stored list of communication elements retrieved from said memory, and prioritize the communication elements that appear on both lists.

6. The apparatus as recited in claim 1 wherein said communications resource comprises a cellular network configured to use spread spectrum signaling over an air interface at radio frequencies.

7. The apparatus as recited in claim 1 wherein said memory and said computer program code are configured to, with said processor, cause said apparatus to determine the priority scheme by retrieving a list of communication elements that the apparatus had previously received signals from over the communications resource, determine the communication elements that the apparatus had most recently communicated with, and assign a priority to those communication elements.

8. The apparatus as recited in claim 1 wherein said memory and said computer program code are configured to, with said processor, cause said apparatus to determine the priority scheme by retrieving a list of communication elements for which the apparatus is a member of a closed subscriber list, to determine the communication elements on the list that the apparatus had most recently communicated with over the communications resource, and assign a priority to those communication elements.

9. The apparatus as recited in claim 1 wherein said memory and said computer program code are configured to, with said processor, cause said apparatus to determine the priority scheme by retrieving a list of communication elements that are within acceptable receiving range for the apparatus based on prior monitoring of signals received from these communication elements over the communications resource, and assign a priority to those communication elements.

10. The apparatus as recited in claim 1 wherein said memory and said computer program code are configured to, with said processor, cause said apparatus to measure the RSTD by receiving a positioning reference signal (PRS) from at least one of the communication elements over the communications resource.

11. A computer program product comprising a program code stored in a computer readable medium configured to:
receive a request over a communications resource to perform a received signal time difference (RSTD) measurement by monitoring communications signals from a plurality of communication elements;
determine a priority scheme for the communication elements for making RSTD measurements for selected ones of the plurality of communication elements;
measure a RSTD for at least one of the selected ones of the plurality of communication elements; and
store the measured RSTD in a memory.

12. The computer program product as recited in claim 11 wherein said program code stored in said computer readable medium is further configured to transmit said measured RSTD over said communications resource.

13. The computer program product as recited in claim 11 wherein said program code stored in said computer readable medium is further configured to measure an RSTD for at least three communication elements; store the measured RSTD for each of the at least three communication elements in the memory; and transmit the measured RSTD for each of the at least three communication elements over said communications resource.

14. The computer program product as recited in claim 11 wherein said program code stored in said computer readable medium is further configured to determine said priority scheme by receiving a list of communication elements over said communications resource, compare said received list to a stored list of communication elements retrieved from said memory, and prioritize the communication elements that appear on both lists.

15. A method, comprising:
receiving a request over a communications resource to perform a received signal time difference (RSTD) measurement by monitoring communications signals from a plurality of communication elements;
determining a priority scheme for the communication elements for making RSTD measurements for selected ones of the plurality of communication elements;
measuring a RSTD for at least one of the selected ones of the plurality of communication elements; and
storing the measured RSTD in a memory.

16. The method as recited in claim 15 further comprising transmitting said measured RSTD over said communications resource.

17. The method as recited in claim 15 further comprising measuring an RSTD for at least three communication elements; storing the measured RSTD for each of the at least three communication elements in the memory; and transmitting the measured RSTD for each of the at least three communication elements over said communications resource.

18. The method as recited in claim 15 further comprising determining said priority scheme by retrieving a stored list of communication elements from said memory.

19. The method as recited in claim 15 further comprising determining said priority scheme by receiving a list of communication elements on said communications resource, comparing said received list to a stored list of communication elements retrieved from said memory, and prioritizing the communication elements that appear on both lists.

20. The method as recited in claim 15 wherein said communications resource comprises a cellular network configured to use spread spectrum signaling over an air interface at radio frequencies.
